(19) United States
(12) Patent Application Publication
(10) Pub. No.: US 2006/0024209 A1
(43) Pub. Date: Feb. 2, 2006

(54) Apparatus, methods, and kits for assaying a plurality of fluid samples for a common analyte

(76) Inventor: Brian J. Agnew, Eugene, OR (US)

Correspondence Address: KOREN ANDERSON;MOLECULAR PROBES, INC., 29851 WILLOW CREEK ROAD, EUGENE, OR, 97402-9132, US

(21) Appl. No.: 11/193,069

(22) Filed: Jul. 28, 2005

Related U.S. Application Data
(60) Provisional application No. 60/592,482, filed on Jul. 30, 2004.

(51) Int. Cl. B01L 3/00

(52) U.S. Cl. 422/100

(57) ABSTRACT

Methods and apparatus useful for the processing of fluid samples are disclosed. The apparatus can be used to process samples containing one or more biological, chemical, or clinical analytes of interest. The apparatus contains a microplate component and a backing plate. The microplate component and/or the backing plate can have a matrix of throughbores, each being mutually fluidly noncommunicating with each other. The support can be fixedly positioned between the microplate component and the backing plate, and can be removed from the apparatus for further processing.

### CROSS REFERENCE TO RELATED APPLICATIONS

The present application claims priority to U.S. Provisional Patent Application Ser. No. 60/592,482 filed Jul. 30, 2004, the contents of which are incorporated herein by reference.

### FIELD OF THE INVENTION

The invention relates to an apparatus and method useful for the detection of biological and chemical analytes. More specifically, a microplate apparatus for the analysis of fluid samples is disclosed.

### DESCRIPTION OF RELATED ART

A wide variety of analytical determinations in molecular and cellular biology call for the assay of a plurality of samples for a common analyte. Often such samples are fluid samples and the assays are conducted in parallel in the liquid phase.

Microplates (synonymously, “microtiter plates”) of ever increasing density, robotics for fluid handling, and automated microplate readers have made it possible to conduct such assays in highly parallel fashion with high throughput. To facilitate such automation, microplate dimensional standards have been established.

Despite the availability of standardized microplates and automation, however, fluid phase assays conducted in parallel have disadvantages, particularly if the assays are conducted on a smaller scale not well suited to automation.

One such disadvantage is the need for repeated pipetting actions, each conducted in parallel, with the consequent requirement for repeated change in, or flushing of, pipette tips. Another is the difficulty of removing contaminants present in the sample that interfere with the assay.

Solid phase assays, in which the samples are immobilized to a solid support, such as a membrane filter, solve certain of these problems.

With a plurality of samples immobilized to discrete and separately addressable locations on a common support, certain assay steps, such as staining, can be conducted in a single tray, reducing the number of pipetting actions while maintaining the parallelism of the assay. Solid phase assays also permit contaminants to be removed, prior to assay, by simple washing of the support.

Solid phase assays cannot, however, readily be interfaced with the infrastructure, now widely established, for conducting assays in microplates.

Dot blot manifolds that permit a plurality of liquid samples to be disposed in spatially addressable format on a common filter are known in the art.

Because such manifolds are often configured to permit vacuum-driven sample application, however, they are often designed to assemble with sealing means adequate to maintain a vacuum; the manifolds, when assembled, typically exceed the size standards that would permit them to be used in commercial microplate readers.

There is thus a need in the art for apparatus and methods that would permit a plurality of fluid samples to be assayed in parallel for a common analyte, and that would combine the advantages of microplate-based fluid assays with the use of solid supports. In particular, there is a need in the art for apparatus and methods that would facilitate the separately addressable disposition of a plurality of fluid samples onto a common solid phase support, and that would permit analytes immobilized on the solid phase support to be detected using apparatus adapted to accommodate microplates meeting established dimensional standards.

### SUMMARY OF THE INVENTION

An apparatus that facilitates the separately addressable disposition of multiple fluid samples onto a common solid phase support is disclosed, as are methods for its use. The apparatus contains a microplate component and a backing plate. The microplate component and/or the backing plate can have a matrix of throughbores, each being mutually fluidly noncommunicating with each other. The support can be fixedly positioned between the microplate component and the backing plate, and can be removed from the apparatus for further processing.

### DESCRIPTION OF THE FIGURES

The following figures form part of the present specification and are included to further demonstrate certain aspects of the present invention. The invention may be better understood by reference to one or more of these figures in combination with the detailed description of specific embodiments presented herein.

FIG. 1 is an exploded bottom perspective view of an apparatus according to the present invention, showing microplate component 10 and backing plate 20 to which it can be reversibly mated;

FIG. 2 is an exploded bottom perspective view of an apparatus according to the present invention with common support 30, fashioned as a sheet, shown positioned between microplate component 10 and backing plate 20;

FIG. 3 is a plan view of the top of an exemplary microplate component of an apparatus of the present invention;

FIG. 4 is a top perspective view of an exemplary microplate component of an apparatus of the present invention;

FIG. 5 is a bottom perspective view of an exemplary microplate component of an apparatus of the present invention;

FIG. 6 is a plan view of the top of an exemplary backing plate of an apparatus of the present invention;

FIGS. 7-9 demonstrate assembly of an exemplary apparatus according to the present invention, with FIG. 7 showing insertion of a support sheet between the recessed bottom of the microplate component and the microplate-proximal side of the backing plate, with FIG. 8 showing inward compression of an integral spring element of the backing plate, and FIG. 9 showing engagement and frictional retention of the backing plate within a recess on the bottom side of the microplate component, fixedly positioning the support sheet between the bottom of the microplate component and the backing plate;

FIGS. 10A and 10B are exemplary standard curves for total protein analysis using an apparatus and methods of the present invention, with the values in FIG. 10A provided by scanning the analyte-spotted support with a 473 nm laser-based scanner and the values in FIG. 10B provided by a fluorescence microplate reader; and

FIG. 11 is a bar graph illustrating protein-to-protein variation in a total protein assay performed using an apparatus and methods of the present invention.

### DETAILED DESCRIPTION OF THE INVENTION

While compositions and methods are described in terms of “comprising” various components or steps (interpreted as meaning “including, but not limited to”), the compositions and methods can also “consist essentially of” or “consist of” the various components and steps, such terminology should be interpreted as defining essentially closed-member groups.

The present invention solves multiple needs in the art, by providing, in a first aspect, apparatus that facilitates the separately addressable disposition of a plurality of fluid samples onto a common solid phase support, and that permits analytes immobilized on the solid phase support thereafter to be detected using apparatus adapted to accommodate microplates meeting established dimensional standards.

The apparatus comprises a microplate component and a backing plate.

The microplate component has a matrix of throughbores, the throughbores being mutually fluidly noncommunicating within the microplate component.

The microplate component and backing plate are configured to mate reversibly and to matedly fix a unitary solid phase support, such as a single sheet of filter paper, therebetween. The solid phase support is so positioned in the mated assembly as to be in fluid communication with, and to occlude passage through, at least a plurality, typically all, of the microplate component throughbores, converting such throughbores into wells.

The mated assembly does not exceed in outermost dimensions the outermost dimensions of the microplate component. In typical embodiments, the mated assembly is so dimensioned as to satisfy microplate dimensional standards.

In some embodiments, the microplate component has 96 throughbores disposed in an 8×12 matrix; in still other embodiments, the microplate component has 384 throughbores disposed in a 16×24 matrix.

In certain embodiments that permit particular flexibility in assay detection, the backing plate too has a matrix of throughbores, the throughbores being mutually fluidly noncommunicating within the backing plate. Typically, the backing plate throughbores are alignable with the throughbores of the microplate component in the assembled apparatus, usefully in any of a plurality of relative orientations of the microplate component and backing plate.

The microplate component and the backing plate are, in typical embodiments, substantially rigid.

The backing plate can usefully, however, be inwardly and elastically compressible, optionally, but usefully, in a single axis.

In some compressible embodiments, the backing plate has at least one integrally fashioned spring element that is inwardly and elastically compressible, such as a spring element formed by the positioning of a void inwardly offset from and parallel to the backing plate periphery. In some of these embodiments, the void is positioned in the backing plate external to the outwardmost row of throughbores, if present.

The backing plate can further comprise means for discontinuous distribution of outward force by a spring element, thus increasing the outward (decompressive) force exerted by the spring element at desired locations of the backing plate periphery. Such means can include outward protrusions disposed peripherally to the spring element.

The microplate component, in some embodiments, has a recessed bottom, the recess so dimensioned as to accommodate and frictionally retain the mated backing plate. In embodiments in which the backing plate is inwardly compressible, the microplate component recess is usefully so dimensioned as to accommodate the backing plate in its inwardly compressed state and frictionally retain the mated backing plate in its uncompressed state.

In some embodiments, the backing plate has at least one chamfer, which can usefully facilitate its disassembly from the microplate component recess.

Apparatus of the present invention will, in use, typically further comprise a solid phase support, typically fashioned as a sheet, fixedly positioned between the mated microplate component and backing plate. In the mated assembly, the support is so positioned as to be in fluid communication with, and to occlude passage through, at least a plurality of microplate component throughbores, converting such throughbores to wells. In typical embodiments, the support is so positioned as to occlude passage through all of the microplate component throughbores.

In embodiments in which the backing plate comprises throughbores, the solid phase support is so positioned in the mated assembly as to be in fluid communication additionally with, and to occlude passage through, at least a plurality, often all, of the backing plate throughbores.

In a second aspect, the invention provides methods of commonly assaying a plurality of fluid samples for one or more desired analytes.

The method comprises disposing at least one aliquot from each of the plurality of fluid samples at separately addressable locations on a common solid phase support; the support is fixedly positioned between the mated microplate component and backing plate of apparatus of the present invention.

The solid phase support is then removed from the apparatus, and the sample aliquots addressably disposed on the solid phase support are placed in common fluid communication with at least one solution, the solution comprising at least one reagent capable of signaling the presence of the one or more desired analytes.

Subsequent to this “staining” step, signal is assessed at each of the separate addresses on the common solid phase support.

In certain embodiments, the method further comprises fixedly repositioning the solid phase support between the microplate component and backing plate of the apparatus after the staining step and before detecting signal; and then separately detecting signal at each of the separate addresses on the fixedly positioned solid phase support.

In some embodiments, the sample aliquots are contacted to the common solid phase support through throughbores in the microplate component. In other embodiments of the methods of the present invention, the sample aliquots are contacted to the solid phase support through backing plate throughbores.

Usefully, but optionally, the methods of the present invention can include washing of the solid phase support, either before or after the staining step; washing usefully removes contaminants that might interfere with the assay.

In some embodiments of the methods of the invention, the one or more signaling reagents is capable of signaling the presence of the one or more desired common analytes calorimetrically; in other embodiments, the signaling reagents are capable of signaling analyte presence fluorescently; in other embodiments, luminescently.

The analytes to be commonly detected in the plurality of fluid samples can be proteins, nucleic acids, sterols, lipids, polysaccharides, antibodies, small molecules, or any naturally-occurring or nonnaturally-occurring analyte capable of detection.

In another aspect, the invention provides a kit for commonly assaying a plurality of fluid samples for one or more desired analytes.

In its simplest embodiments, the kit comprises at least one microplate component and at least one backing plate configured to mate reversibly thereto. In some embodiments, the kit comprises a plurality of either or both of the microplate component and backing plate. In typical embodiments, the one or more backing plates has a matrix of throughbores.

In some embodiments, the kit usefully further comprises at least one solid phase support so dimensioned as to be fixedly positionable between the microplate component and backing plate of the kit. In typical embodiments, the kit comprises a plurality of such supports.

In some of these latter embodiments, the plurality of supports are identical to one another in size and composition. In other embodiments, the supports differ in composition, with the compositions differing in suitability for various analytes that may be desired to be detected. In certain of these latter embodiments, the kit comprises a plurality of supports of each of the plurality of compositions, with the supports of identical composition commonly containered.

The solid phase support or plurality of supports included within the kit can, in some embodiments, include at least one indicium that facilitates the identification of its orientation.

In addition, the kits can optionally, but usefully, comprise at least one analyte standard. For example, kits intended for measurement of total protein can usefully include a protein standard, either dry and of known weight or in solution of known concentration.

One embodiment of the invention provides an apparatus suitable for separately addressable disposition of a plurality of fluid samples onto a common support that is reversibly fixed therein.

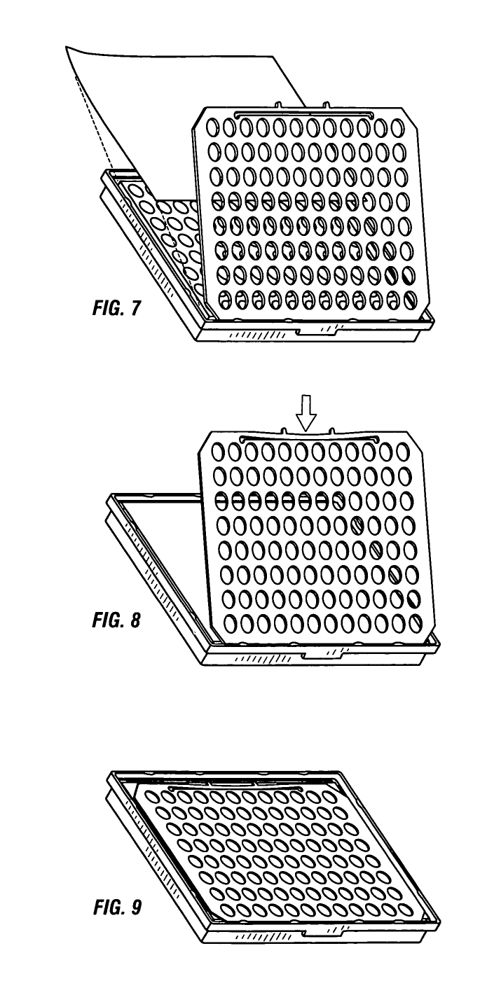

With reference to FIG. 1, an exploded bottom perspective view of an exemplary apparatus of the present invention is shown. Apparatus 100 comprises microplate component 10 and backing plate 20, which are configured to mate reversibly with one another, as further illustrated in FIGS. 7-9, further described below.

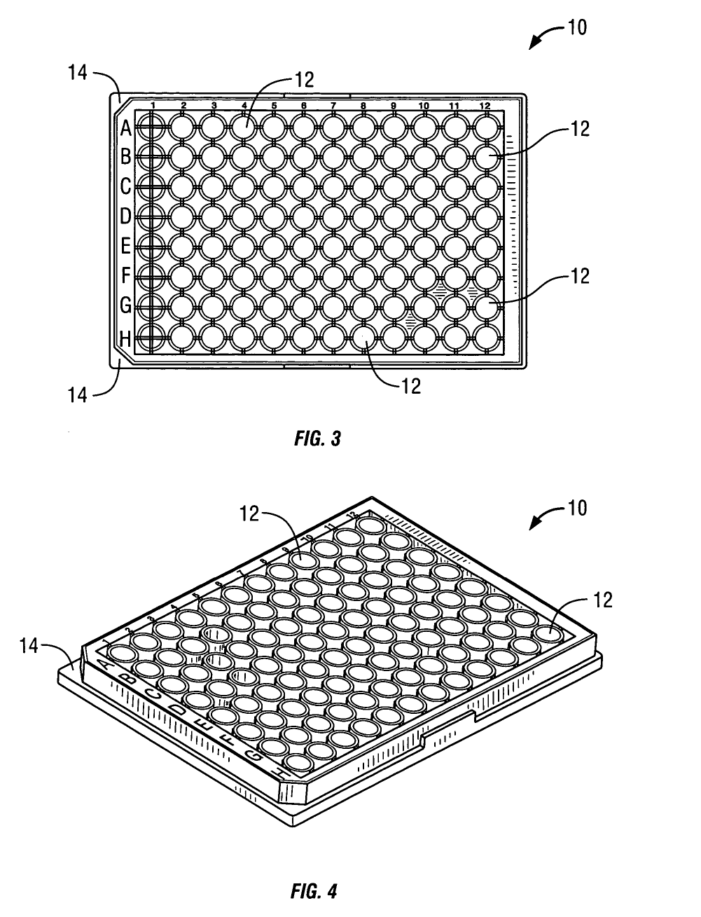

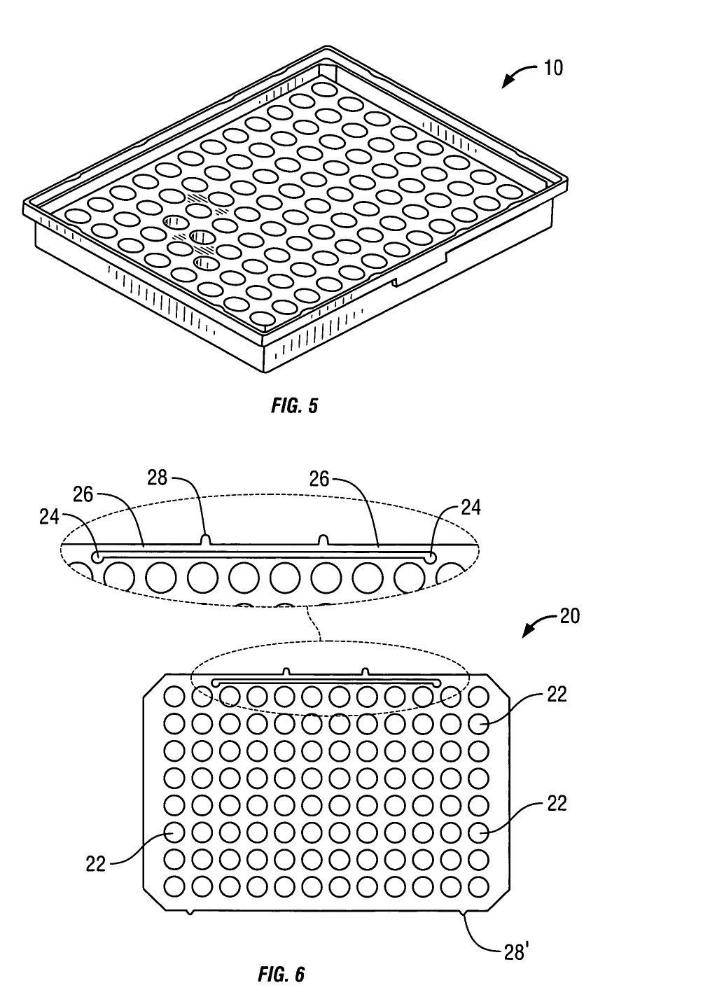

Microplate component 10, shown in greater detail in FIGS. 3-5, has a matrix of throughbores 12. The throughbores are mutually fluidly noncommunicating within microplate component 10.

In typical embodiments, the microplate component comprises 96 throughbores in an 8×12 matrix. In other embodiments, the microplate component can comprise 384 throughbores in a 16×24 matrix, 1536 throughbores in a 32×48 matrix, or other numbers of throughbores, such as 864, 3456, 6144, even 9600 throughbores, in various geometries.

In typical embodiments, microplate component throughbores 12 satisfy the standard for microplate well position set forth in ANSI/SBS 4-2004, incorporated herein by reference in its entirety.

In embodiments having 96 throughbores, for example, throughbores 12 are typically arranged in a matrix having eight rows by twelve columns. The distance between the left outside edge of microplate component 10 and the center of the first column of throughbores 12 in these embodiments is about 14.38 mm; each following column is an additional about 9.0 mm in distance from the left outside edge of microplate component 10. The distance between the top outside edge of microplate 10 and the center of the first row of throughbores 12 is about 11.24 mm; each following row is an additional about 9.0 mm in distance from the top outside edge of the plate. The center of each throughbore 12 will be within about 0.70 mm diameter of the specified location.

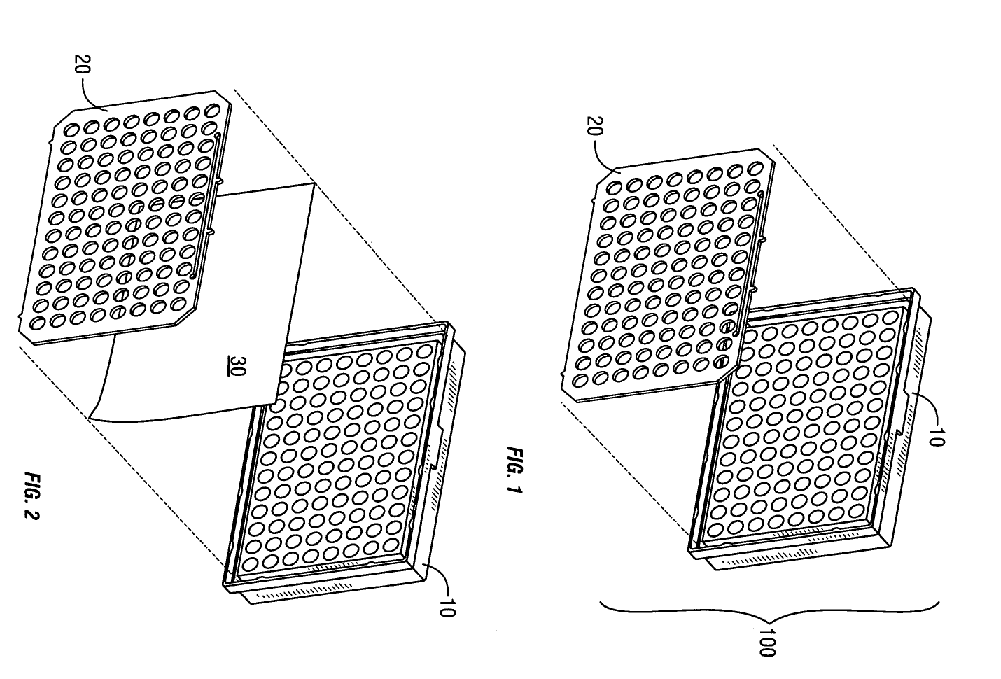

In typical embodiments, the top left throughbore 12 of microplate component 10 is marked in a distinctive manner. Such distinguishing marks include, but are not limited to, marking of the top left well of the plate with the letter A or numeral 1 located on the left-hand side of the well, as shown in FIGS. 2A and 2B and/or marking of the top left well of the plate with a numeral 1 located on the upper side of the well, as shown in FIGS. 2A and 2B.

Additional markings can be included in various embodiments. For example, as illustrated in the exemplary microplate component shown in FIGS. 3 and 4, each row of throughbores 12 can be separately labeled with a distinctive indicium, such as a distinct letter, and each column can be labeled with a distinctive indicium, such as a distinct numeral. Non-numeric or non-letter marks may also be used, such as circles, plus-signs, dashes, dots, and so on.

In embodiments having 384 throughbores that satisfy the standard for microplate well position set forth in ANSI/SBS 4-2004, the throughbores are arranged in a matrix having sixteen rows by twenty-four columns.

Typically, the distance between the left outside edge of microplate component 10 and the center of the first column of throughbores 12 in the 384 throughbore embodiments is about 12.13 mm; each following column is an additional about 4.5 mm in distance from the left outside edge of microplate component 10. In these embodiments, the distance between the top outside edge of microplate component 10 and the center of the first row of throughbores 12 is about 8.99 mm, with each following row an additional about 4.5 mm in distance from the top outside edge of microplate component 10. The center of each throughbore 12 is within about 0.70 mm diameter of the specified location.

As with the 96 throughbore embodiments, the top left well of microplate component 10 in the 384 throughbore embodiments can usefully be marked with an identifying indicium, and each row and column can usefully be separately and distinctly so marked.

In 1536 well embodiments that satisfy the ANSI/SBS 4-2004 standard, throughbores 12 are arranged in a matrix having thirty-two rows by forty-eight columns. The distance between the left outside edge of microplate 10 and the center of the first column of throughbores 12 is about 11.005 mm, with each following column an additional about 2.25 mm in distance from the left outside edge of the microplate component.

In these 1536 throughbore embodiments, the distance between the top outside edge of microplate component 10 and the center of the first row of throughbores 12 is typically about 7.865 mm. Each following row is an additional about 2.25 mm in distance from the top outside edge of the plate. The center of each throughbore is within about a 0.50 mm diameter of the specified location.

Analogously, the top left throughbore in these high density embodiments is typically marked in a distinguishing manner, with typical embodiments usefully having each row and column separately and distinctly marked.

Backing plate 20 can optionally, but usefully, have a matrix of throughbores 22 (see FIG. 6).

When present, throughbores 22 of backing plate 20 are mutually fluidly noncommunicating within the backing plate.

In addition, throughbores 22 of backing plate 20 are typically congruent with those of microplate component 10 to which backing plate 20 is intended to be mated in apparatus 100: that is, in typical embodiments, backing plate 20 has the same number, shape, size and location of throughbores as the microplate component to which it is intended to be mated. In addition, throughbores 22 of backing plate 20 are typically alignable with throughbores 12 of the microplate component in the assembled apparatus, each pair of aligned throughbores 12 and 22 creating a through passage through apparatus 100.

These latter embodiments of backing plate 20 are particularly useful when, as further described below, support 30 is fixedly repositioned in the apparatus to permit detection of support-bound analyte using a reader configured to detect signal from beneath a microplate.

In other embodiments, backing plate 20 can have a greater number of throughbores than microplate component 10 to which the backing plate is to be mated.

In embodiments of backing plate 20 having throughbores 22, the matrix of throughbores can usefully be symmetrically positioned in backing plate 20, permitting alignment of throughbores 22 and microplate component throughbores 12 in any of a plurality of relative orientations of the microplate component and backing plate.

For example, in the exemplary embodiment illustrated in FIGS. 7-9, in which backing plate 20 is accommodated and frictionally retained in a recess in the bottom of microplate component 10, throughbores 22 of backing plate 20 can align with throughbores 12 of microplate component 10 in any of four relative orientations of backing plate and microplate component.

Such symmetrical backing plate embodiments facilitate assembly of apparatus 100 without regard for the relative orientation of the backing plate.

In preferred embodiments of the apparatus of the present invention, such as that illustrated in FIGS. 7-9, the mated assembly of microplate component 10 and backing plate 12 does not exceed in outermost dimensions the outermost dimensions of the microplate component alone.

In particularly useful embodiments, both microplate component 10 and the assembled apparatus 100 are so dimensioned as to satisfy the microplate dimensional standards collectively set forth in ANSI/SBS 1-2004 (“Footprint Dimension”), ANSI/SBS 2-2004 (“Height Dimensions”), and ANSI/SBS 3-2004 (“Bottom Outside Flange Dimensions”), the disclosures of which are incorporated herein by reference in their entireties.

For example, in typical embodiments, the outside dimension of the base footprint of microplate component 10 and optionally, but usefully, of assembled apparatus 100, measured within 12.7 mm of the outside corners, is about 127.76 mm±0.25 mm in length and about 85.48 mm±0.25 mm in width. The outside dimension of the base footprint, measured at any point along the side, is about 127.76 mm±0.5 mm in length and about 85.48 mm±0.5 mm in width. The footprint is continuous and uninterrupted around the base of the plate. In typical embodiments, the four outside corners of the bottom flange of microplate 10, and optionally but usefully of assembled apparatus 100, have a corner radius to the outside of about 3.18 mm±1.6 mm.

In various of these embodiments, the height of microplate 10, and usefully also the height of assembled apparatus 100, measured from the resting plane to the maximum protrusion of the perimeter throughbores, is about 14.35 mm±0.25 mm, with the overall microplate and assembly height, measured from the resting plane to the maximum protrusion of the plate, about 14.35 mm±0.76 mm. In these embodiments, the maximum allowable projection above the top-stacking surface is typically about 0.76 mm, with the top-stacking surface defined as that surface on which another microplate or assembly would rest when stacked one on another. When resting on a flat surface, the top surface of the plate is usefully parallel to the resting surface within about 0.76 mm.

With clearances, such embodiments usefully have height of microplate component 10, and optionally but usefully of assembled apparatus 100, measured from the resting plane to the maximum protrusion of the perimeter throughbores, of about 14.35 mm±0.25 mm. The maximum allowable projection above the top-stacking surface in these embodiments is about 0.76 mm; the top-stacking surface is defined as that surface on which another microplate, or assembled apparatus, would rest when stacked one on another. When resting on a flat surface, the top surface of the microplate, or assembly, in typical embodiments is parallel to the resting surface within about 0.76 mm.

In typical embodiments, the minimum clearance from the resting plane to the plane of the bottom external surface of the throughbores is about 1 mm. This clearance is limited to the area of the throughbores.

Optionally, but typically, microplate component 10 comprises bottom outside flange 14 (see FIGS. 3 and 4).

In typical flange-containing embodiments of microplate component 10 having short flange heights, the height of the bottom outside flange 14 is about 2.41 mm±0.38 mm measured from the bottom-resting plane to the top of the flange, with all four sides have the same flange height. The width of the bottom outside flange measured at the top of the flange is typically a minimum of 1.27 mm. Corner notches (“chamfers”), are optionally present at one or more corners; in embodiments having chamfers, the chamfer does not include the flange.

In embodiments having medium flange height, the height of the bottom outside flange is about 6.10 mm±0.38 mm measured from the bottom-resting plane to the top of the flange. In such embodiments, the width of the bottom outside flange measured at the top of the flange is typically a minimum of about 1.27 mm.

In embodiments having a tall flange height, the height of the bottom outside flange is about 7.62 mm±0.38 mm measured from the bottom-resting plane to the top of the flange. The width such bottom outside flanges, measured at the top of the flange, is typically a minimum of about 1.27 mm.

In yet other embodiments, the flange can be interrupted.

Typically, both microplate component 10 and backing plate 20 are substantially rigid.

Microplate component 10 is typically composed of plastic, such as polystyrene (usefully virgin polystyrene) or polypropylene, and can manufactured by thermoforming or other techniques well known in the art.

The composition can usefully be chosen to be substantially chemically resistant to the liquid samples with which it is to come into contact, and usefully does not bind substantial amounts of analyte desired to be detected in the liquid sample. The microplate component can be of uniform composition, or can in alternative embodiments include surface modifications. For example, the interior surfaces of throughbores 12 can be modified to create a nonionic hydrophilic surface (polyethylene oxide-like) that minimizes molecular interactions in order to reduce protein and nucleic acid binding at low concentrations, and thus increase assay signal to noise.

The microplate component can usefully be transparent when colorimetric assays are intended; opaque or black when fluorescence or luminescence-based assays are intended; or translucent, or white, or other colors, such as when an assay is intended to be read without reassembly of the apparatus, as further described below.

Backing plate 20 is typically composed of material that is both substantially rigid and substantially incompressible, such as hard plastic, polytetrafluoroethylene, metal, for example steel, or aluminum, or alloys thereof. Throughbores and other features can be formed by known techniques, such as drilling, etching, or die cutting.

In certain embodiments, backing plate 20 is inwardly and elastically compressible in one or more axes.

FIG. 6 shows an exemplary embodiment of backing plate 20 that is inwardly and elastically compressible in substantially a single axis.

As shown, backing plate 20 has an integrally fashioned spring element 26. Spring element 26 is formed by the positioning of an adjacent void 24; in the embodiment shown, void 24 is inwardly offset from and parallel to the backing plate periphery. In the embodiment illustrated, void 24 is positioned in the backing plate external to the outwardmost row of throughbores in the backing plate throughbore matrix.

Spring element 26 renders backing plate 20 inwardly compressible in the direction of void 24, with inward compression substantially collapsing void 24, as illustrated in FIG. 8. Composed of an otherwise substantially incompressible material, such as metal, spring element 26 can elastically recoil outwards upon release of inward compressive force.

Although only a single spring element 26 formed by a single void 24 is shown in FIGS. 6-9, multiple spring elements 26 can be included in backing plate 20, each created by one or more voids 24.

Backing plate 20 can usefully further comprise means for discontinuous distribution of outward force by spring element 26, thus increasing the outward (decompressive) force exerted by spring element 26 at desired locations of the backing plate periphery.

For example, as shown in FIG. 6, backing plate 20 can usefully include at least one, typically at least two, outward protrusions 28 disposed peripherally to spring element 26, and optionally one or more protrusions 28′ positioned on the opposite periphery of the backing plate.

In certain embodiments, microplate component 10 has a recessed bottom, the recess dimensioned to fully accommodate backing plate 20.

In typical embodiments, the recess is so dimensioned as to fully accommodate and frictionally retain backing plate 20 therein. In embodiments in which backing plate 20 is inwardly and elastically compressible, the recess in the bottom of microplate component 10 is usefully dimensioned so as to accommodate backing plate 20 in its inwardly compressed state and frictionally retain backing plate 20 in its uncompressed state, as illustrated in FIGS. 7-9, further described below.

Optionally, backing plate 20 can include at least one chamfer, which usefully facilitates disassembly from microplate component 10, particularly in embodiments in which backing plate 20 is fully accommodated and frictionally retained within a bottom recess of microplate component 10.

In other embodiments, backing plate 20 is hingeably attached to microplate component 10.

The apparatus of the present invention is suitable for the disposition of a plurality of fluid samples onto a common support that is reversibly fixed therein.

Accordingly, apparatus of the present invention will, in use, typically further comprise support 30, as illustrated in FIG. 2.

Typically, support 30 will be substantially planar, typically formed as a sheet.

The support may be either porous or nonporous. The composition chosen will typically depend upon the type of assay desired to be conducted using the apparatus of the present invention. Suitable compositions, and the choice among them, is well within the skill in the analytical arts.

Suitable support compositions include, for example, paper (cellulose), nitrocellulose, nylon, positively charged derivatized nylon, glass fiber filter, polyvinylidene fluoride membrane filters, cellulose acetate filters, cellulose nitrate filters, filters comprising mixtures of cellulose acetate and cellulose nitrate, and PTFE membrane bonded to a high density polyethylene support.

As illustrated in FIGS. 2 and 7-9, support 30 is removably positionable between the unassembled microplate component and backing plate, and is fixedly positioned between microplate component 10 and backing plate 20 in the mated assembly.

In the embodiment of the apparatus of the present invention shown in FIGS. 7-9, support 30, formed as a sheet, is first placed in bottom recess of microplate component 10 (FIG. 7); support 30 is so dimensioned as to be accommodated in its entirety within the microplate bottom recess. In certain embodiments, support 30 is sized and dimensioned to as to fit snugly within the recess. FIG. 8 shows inward compression of backing plate 20 by inward compression of spring element 26, collapsing void 24. FIG. 9 shows the final assembly step, in which backing plate 20 is fully inserted in the bottom recess of microplate component 10, where it is frictionally retained by outward forces created by decompression of backing plate spring element 26.

So assembled, microplate component 10 and backing plate 20 hold support 30 fixedly in position; support 30 is so positioned in the mated assembly as to be in fluid communication with, and to occlude passage through, at least a plurality, typically all, of the microplate component throughbores, converting such throughbores into wells.

Optionally, support 30 can include at least one indicium useful for identifying its orientation within the apparatus.

For example, support 30 can include a chamfer or other physical asymmetry. Alternatively, or in addition, support 30 can include one or more indicia that are detectable either to the naked eye or to the apparatus used for analyte detection. The indicia can be detectable before wetting or after.

In some embodiments, the indicia can include desired analytes in known amount. For example, in supports to be used to detect and quantify total protein, the indicia can include protein in a known amount, both to facilitate determination of the support orientation and to serve as a control.

The support can optionally, but usefully, be scored or perforated to permit separation. For example, a score or perforation may bisect the support to permit use of half of the support should the plurality of samples to be assayed not require an entire support. In other embodiments, scores or perforations may be present that facilitate the separation and isolation of each addressably disposed sample aliquot, for example to permit subsequent individualized elution and further analysis.

In a second aspect, the invention provides methods of using the apparatus, assembled with a support held fixedly between microplate component and backing plate, to assay a plurality of fluid samples for one or more desired common analytes.

In a first step, at least one aliquot from each of the plurality of fluid samples is disposed at separately addressable locations on the common support.

As noted above, the support is so positioned in the mated assembly as to be in fluid communication with, and to occlude passage through, at least a plurality, typically all, of the microplate component throughbores, converting such throughbores into wells.

Thus, in one series of embodiments, the sample aliquots are loaded into separate wells of the microplate component.

The wells will often approximate in volume the volume of standard microplate wells, with working volumes for 96 well embodiments of at least about 10 μL, 20 μL, 30 μL, 40 μL, 50 μL, 60 μL, even at least about 70 μL, 80 μL, 90 μL, 100 μL, 150 μL even 200 μL or more, and minimum volumes of no more than about 200 μL, 150 μL, 100 μL, 90 μL, 80 μL, 70 μL, 60 μL even no more than about 50 μL, 40 μL, 30 μL, 20 μL, or 10 μL per well, with average working volumes of 75 μL to about 200 μL typical, with intermediate values permissible.

The volume of fluid sample is chosen to ensure that samples do not coalesce on the common support; smaller volumes are typically chosen when the support is bibulous and permits substantial outward wicking of fluid from the point of contact with the support. Typically, a volume is chosen that can, in addition, readily and quickly be dried on the support, such as by exposure to air, optionally by exposure to heat, as, for example, by heat from a hair drier.

The aliquot can conveniently be about 0.5 μL, 1.0 μL, 1.5 μL, 2.0 μL, 2.5 μL, 3.0 μL, 3.5 μL, 4.0 μL, 4.5 μL, 5.0 μL, 5.5 μL, 6.0 μL, even as much as about 10 μL, 11 μL, 12 μL, 13 μL, 14 μL, even as much as 15 μL or more, with intermediate volumes permissible and volumes of about 1 μL typical in embodiments in which the microplate component has a matrix of 96 throughbores.

In embodiments of the apparatus in which the backing plate has throughbores, the common support is additionally in fluid communication with, and occludes, the backing plate throughbores, converting such throughbores into wells. Such wells will typically be more shallow than those formed in the microplate component, and thus have lesser working volume.

In such embodiments, the sample aliquots can alternatively be loaded into separate wells of the backing plate component.

The volume of fluid sample is chosen to ensure that samples do not coalesce on the support; smaller volumes are typically chosen when the support is bibulous and permits substantial outward wicking of fluid from the point of contact with the support. Typically, a volume is chosen that, in addition, can readily and quickly be dried on the support, such as by exposure to air, optionally by exposure to heat, as, for example, by heat from a hair drier.

In addition, the volume is chosen so as to not overtop the backing plate wells.

In such embodiments, volumes of no more than about 2.0 μL, 1.5 μL, 1.0 μL, and even no more than about 0.5 μL are typically contacted to the common support, with intermediate values permissible.

The sample aliquots can be applied serially, using a manual pipette. Conveniently, a plurality of aliquots can be applied concurrently using a multichannel pipette having 8 or 12 channels. Higher throughput can be achieved using robotic apparatus.

The common support is then removed from the apparatus by unmating the microplate component and backing plate.

The support is then contacted—as by immersion to at least one solution, the solution comprising at least one reagent capable of signaling the presence of the one or more desired analytes; the plurality of sample aliquots addressably disposed on the support are thereby placed in common fluid communication with the reagent solution.

As is well-known in the analytical arts, the signaling reagents are chosen based upon the chemical properties of the analyte desired to be detected and the sensitivity desired. The reagents in some embodiments will signal the presence of desired analyte calorimetrically; in other embodiments, fluorescently; in yet other embodiments, luminescently.

By way of example, Table 1 lists reagents that may usefully be adapted for detecting and quantifying proteins in the methods of the present invention. The reagents are available commercially under the listed catalogue numbers from Invitrogen Corp. (Carlsbad, Calif.).

| | | Sensitivity | | |
|---|---|---|---|---|
| | Detection | and | | |
| Assay | Wavelengths | Effective | Mechanism of | |
| (Catalogue No.) | (nm)* | Range | Action | Notes |
| NanoOrange | 485/590 | 10 ng/mL to | Binds to detergent | High sensitivity |
| protein | | 10 μg/mL | coating on | Little protein-to- |
| quantitation assay | | | proteins and | protein variation |
| (N6666) | | | hydrophobic | Rapid and |
| | | | regions of | accurate assay |
| | | | proteins; the | with a simple |
| | | | unbound dye is | procedure |
| | | | nonfluorescent | Compatible with |
| | | | | reducing agents |
| CBQCA protein | 450/550 | 10 ng/mL to | Reacts with | Sensitivity |
| quantitation assay | | 150 μg/mL | primary amine | depends on the |
| (C6667) | | | groups on | number of amines |
| | | | proteins in the | present |
| | | | presence of | Not compatible |
| | | | cyanide or thiols; | with buffers |
| | | | the unbound dye | containing amines |
| | | | is nonfluorescent | or thiols |
| | | | | High sensitivity |
| | | | | Linear over an |
| | | | | extended range of |
| | | | | protein |
| | | | | concentration |
| Bradford assay¹ | 595 | 1 μg/mL to | Directly binds | High protein-to- |
| (Coomassie | | 1.5 mg/mL | specific amino | protein variation |
| brilliant blue) | | | acids and protein | Not compatible |
| | | | tertiary structures; | with detergents |
| | | | the dye's color | Rapid assay |
| | | | changes from | Useful when |
| | | | brown to blue | accuracy is not |
| | | | | crucial |
| BCA method² | 562 | 0.5 μg/mL to | Cu²⁺is reduced to | Compatible |
| (bicinchoninic | | 1.2 mg/mL | Cu⁺ in the | with |
| acid) | | | presence of | detergents, |
| | | | proteins at high | chaotropes and |
| | | | pH; the BCA | organic |
| | | | reagent chelates | solvents |
| | | | Cu⁺ ions, forming | Not compatible |
| | | | purple-colored | with reducing |
| | | | complexes | agents |
| | | | | The sample |
| | | | | must be read |
| | | | | within 10 |
| | | | | minutes |
| Lowry assay³ | 750 | 1 μg/mL to | Cu²⁺ is reduced | Lengthy |
| (biuret reagent | | 1.5 mg/mL | to Cu⁺ in the | procedure with |
| plus Folin- | | | presence of | carefully timed |
| Ciocalteu | | | proteins at high | steps |
| reagent) | | | pH; the biuret | Not compatible |
| | | | reagent chelates | with detergents |
| | | | the Cu⁺ ion, then | or reducing |
| | | | the Folin- | agents |
| | | | Ciocalteu reagent | |
| | | | enhances the blue | |
| | | | color | |
| Fluorescamine⁴⁻⁷ | 390/475 | 0.3 μg/mL to | Reacts with | Sensitivity |
| (F2332, F20261) | | 13 μg/mL | primary amine | depends on the |
| | | | groups on | number of |
| | | | proteins; unbound | amines present |
| | | | dye is | Reagent is |
| | | | nonfluorescent | unstable |
| | | | | Not compatible |
| | | | | with Tris or |
| | | | | glycine buffers |
| OPA⁸⁻¹⁰ (o- | 340/455 | 0.2 μg/mL to | Reacts with | Sensitivity |
| phthaldialdehyde) | | 25 μg/mL | primary amine | depends on the |
| (P2331MP) | | | groups on | number of |
| | | | proteins in the | amines present |
| | | | presence of β- | Not compatible |
| | | | mercaptoethanol; | with Tris or |
| | | | unbound dye is | glycine buffers |
| | | | nonfluorescent | Low cost |
| UV absorption¹¹ | 205/280 | 10 μg/mL to | Peptide bond | Sensitivity |
| | | 50 μg/mL or | absorption; | depends on |
| | | 50 μg/mL to | tryptophan and | number of |
| | | 2 mg/mL | tyrosine | aromatic amino |
| | | | absorption | acid residues |
| | | | | present |
| | | | | Nondestructive |
| | | | | Low cost |

*Excitation and emission wavelength maxima or absorbance wavelength maximum, in nm.
Notes:
¹Anal. Biochem. 72, 248 (1976);
²Anal. Biochem. 150, 76 (1985);
³J. Biol. Chem. 193, 265 (1951);
⁴Science 178, 871 (1972);
⁵Clin. Chim. Acta 157, 73 (1986);
⁶J. Lipid Res. 27, 792 (1986);
⁷Anal. Biochem. 214, 346 (1993);
⁸Anal. Biochem. 115, 203 (1981);
⁹Biotechniques 4, 130 (1986);
¹⁰J. Immunol. Methods 172, 141 (1994);
¹¹Protein Purification: Principles and Practice, 2nd Ed., Scopes RK pp. 253-283 (1987).

In addition, the reagent solution provided in the EZQ™ Protein Quantitation Kit (Invitrogen Corp., Carlsbad, Calif.) can usefully signal the presence of protein in the methods of the present invention, as further described in Example 1, below.

Other analytes that may be detected in the methods of the present invention include polysaccharides, sterols, lipids, nucleic acids, antibodies, small molecules, and subsets thereof.

As is well known in the analytical arts, the signaling reagent need not be a single molecular species, but can include, for example, an enzyme and enzyme substrate, a specific binding partner for the analyte desired to be detected, such as an antibody, and one or more additional agents to signal the presence of the specific binding partner.

Where specific binding partners are used, assays can optionally be in a “sandwich” format, in which a first incubation step is performed for binding of a primary specific binding partner (such as an antibody) that binds the analyte, and a second incubation step is subsequently performed for binding of a second specific binding partner (such as an antibody) that comprises a detectable label to the primary specific binding partner.

In a final step, signal is detected at each of the separate addresses on the common support by a detector suited to the signal expected to be generated.

In some embodiments, the signal is detected directly from the support, as by a laser scanner.

The apparatus of the present invention advantageously allows the support upon which sample aliquots are disposed to be fixedly repositioned between the microplate component and the backing plate after contact with the signaling reagent. Thus, in other embodiments of the methods of the present invention, signal can be detected at each addressable location using a standard microplate reader. In embodiments in which the backing plate comprises throughbores, the reader can be either a top- or bottom-reading device.

In some embodiments of the methods of the present invention, the analytes present in the dried aliquots are fixed to the support after its removal from the apparatus and before contact with the one or more signaling reagent (“staining”) solutions by placing the support, as by immersion, in contact with a solution comprising a fixative; the sample aliquots addressably disposed thereon are thereby placed in common fluid communication with the fixing solution. Proteins, for example, can usefully be fixed to the support using solutions comprising methanol.

In some embodiments, the support is washed before contact with the one or more staining solutions; washing can be performed after fixation of the analytes to the support, or in some embodiments without such antecedent fixation.

Washing can usefully remove detergents, reducing agents, chaotropes, and tracking dyes, making the methods useful for determining protein concentrations of samples either prior to, or following, polyacrylamide gel electrophoresis.

In another aspect, the invention provides kits for assaying a plurality of fluid samples for one or more common analytes using the apparatus and methods of the present invention.

The kits comprise at least one microplate component and at least one backing plate configured to mate reversibly thereto. In some embodiments, the kit comprises a plurality of either or both of the microplate component and backing plate. In typical embodiments, the one or more backing plates has a matrix of throughbores.

In some embodiments, the kit usefully further comprises at least one support so dimensioned as to be fixedly positionable between the microplate component and backing plate of the kit.

In typical embodiments, the kit comprises a plurality of such supports.

In some of these embodiments, the plurality of supports are identical to one another in size and composition. In other embodiments, the supports differ in composition, with the compositions differing in suitability for various analytes that may be desired to be detected. In certain of these latter embodiments, the kit comprises a plurality of supports of each of the plurality of compositions, with the supports of identical composition commonly containered.

The kits can optionally, but usefully, comprise at least one analyte standard. For example, kits intended for measurement of total protein can usefully include a protein standard, either dry and of known weight, or in solution of known concentration. The protein can, for example, be ovalbumin.

In various embodiments the kits can further include at least one solution comprising at least one analyte-signaling reagent. For example, in kits intended for measurement of total protein, the kit can further include at least one solution that comprises reagents that signal the presence of protein, such as the reagents set forth in Table 1, above, or the reagents included in the EZQ™ Protein Quantitation Kit (Invitrogen Corp., Carlsbad, Calif.).

The apparatus, methods, and kits of the present invention combine the advantages of microplate-based fluid-phase assays with the advantages of solid phase assays, permitting the separate parallel processing of fluid samples in wells of a microtiter plate using standard approaches, detection of assay signals using standard microtiter plate readers, yet with certain of the intermediate assay steps performed in the solid phase.

The interposed solid phase allows a plurality of samples to be commonly treated without requiring that they be maintained in fluid noncommunication with one another. The ability to wash, stain, and optionally to destain or otherwise further process the samples in a single tray or dish with a single volume of solution substantially reduces the required fluid handling chores, and also confers certain other benefits of solid phase reactions, notably the ability to remove contaminants that may interfere with either the staining reactions or reading. For proteins, these contaminants are typically detergents, such as SDS or lithium dodecyl sulfate, chaotropes such as urea, and various contaminants naturally found in protein fractions.

Disposing samples on a solid support also facilitates the performance of sequential assays on a single set of samples.

For example, the support can be treated with a first signaling reagent (suitable, for example, to signal the presence of phosphoprotein), signal detected and quantified, and the support then treated with a second signaling reagent (suitable, for example, to signal the presence and quantity of total protein). Ratios provided by such serial measurements are particularly useful in monitoring purification efforts.

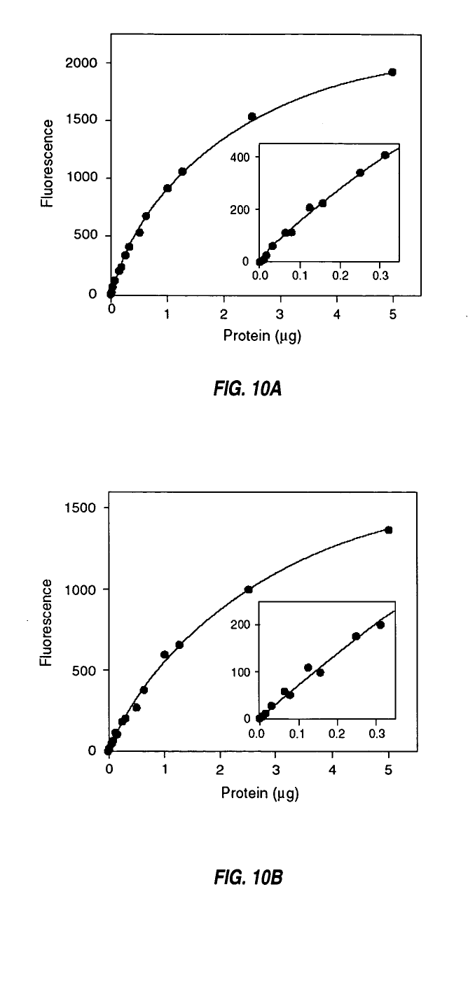

Although clear advantages derive from the ability to reposition the support within the apparatus after staining, and thus perform analyte signal detection using a standard microplate reader, the support can also be scanned without reassembly into the apparatus, as further described in Example 1, below, and FIG. 10B, expanding the detection options.

The following examples are included to demonstrate preferred embodiments of the invention. It should be appreciated by those of skill in the art that the techniques disclosed in the examples which follow represent techniques discovered by the inventor(s) to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

### Example 1

### Exemplary Total Protein Assay

An embodiment of the apparatus, methods, and kits of the present invention—commercially available as the EZQ™ Protein Quantitation Kit (R33200) from Invitrogen Corp. (Carlsbad, Calif.)—are used in this example to quantitate total protein and provide a fast and simple assay for proteins in solution. Because detergents, reducing agents, urea, and tracking dyes do not significantly interfere, this fluorescence-based quantitation kit is useful for determining protein concentrations of samples prior to or following polyacrylamide gel electrophoresis.

The protein assay requires only 1 μL of sample, and up to 96 samples, including standards, can be assayed in one session. In the assay, the protein samples are spotted onto one of the provided assay papers, fixed onto the paper and then stained with our protein quantitation reagent. After spotting the samples, completing the protocol takes only about 1 hour. The protein concentration is determined from a standard curve, and the effective range for the assay is generally 0.02-5 mg/mL, or 0.02-5 μg per spot (see FIGS. 10A and 10B).

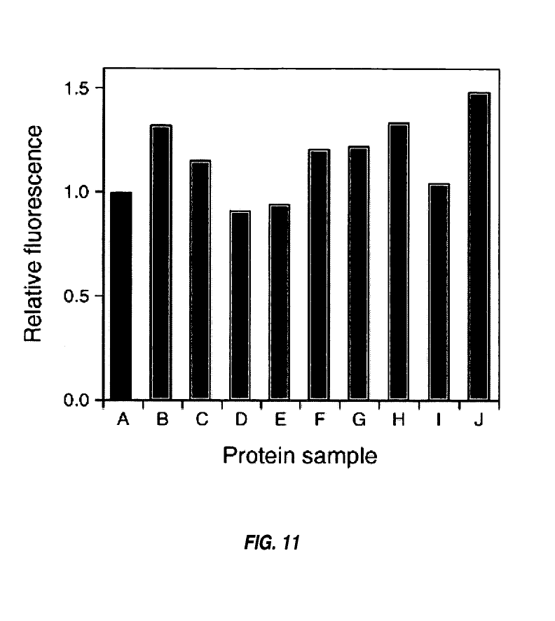

Protein-to-protein sensitivity differences in the assay are minimal—the observed coefficient of variation in a series of exemplary experiments is ˜16% (FIG. 11).

The Protein Quantitation Kit is designed for high-throughput analysis. The solid-phase format and 96-throughbore microplate can be used with readily available fluorescence-detection instruments, for example: (a) fluorescence microplate readers, reading either from the top or bottom of the plate; (b) laser-based scanning instruments, equipped with 450, 473 or 488 nm lasers; (c) UV illuminators in combination with photographic or CCD cameras for image documentation and analysis; and (d) fluorometers.

### Example 2

### Preparation of Ovalbumin Protein Standards

Ovalbumin supplied with the kit can be used to make protein standards for the assay. To make a 10 mg/mL stock solution, add 200 μL of buffer to one vial containing 2.0 mg of ovalbumin, and mix well. The buffer used should be the same as that used for the experimental samples. Dispense aliquots of the stock solution into microcentrifuge tubes and store at −20° C. for future use.

Dilutions can be prepared from the stock solution. Prepare standards by making serial dilutions of the 10 mg/mL ovalbumin stock solution. The dilution buffer should be the same as that used for the experimental samples. Denaturing buffers containing dithiothreitol or TCEP are recommended (see below). At least five concentrations should be used to cover the range expected for the experimental samples. The full effective protein concentration range for this assay is ˜0.02-5 mg/mL. Volumes of 1 μL are used in the assay.

### Example 3

### Preparation of a 96-Well Microplate

Remove the stainless steel backing plate from the microplate component by compressing the spring mechanism. Place the microplate face down on a clean surface. Wearing gloves, place a sheet of assay paper over the microplate, and align the paper with the inner tabs of the top, bottom and left sides of the plate. Mark one corner of the paper with a pencil to identify the orientation. If desired, assay papers can be cut in half and used in the device.

To insert the backing plate, align the backing plate so that the spring element (“spring arm”) furthest from you (although it may also be aligned closest to you). Place the bottom protrusions (“tabs”) of the backing plate along the inner edge of the bottom of the microplate. Depress the spring arm and lower the top of the backing plate into position. The top tabs should contact the inner edge at the top of the microplate. Release the spring arm and check that the paper is held securely in place.

### Example 4

### Loading Protein Standards and Samples

For the following procedure, the concentration of the protein samples should preferably not exceed 5 mg/mL. If the concentration is too high, the samples can be diluted in the same buffer. Denaturing buffers containing dithiothreitol or TCEP are recommended. Ampholytes, up to a concentration of 0.4%, can be included in the sample buffers. If ampholytes are included in the experimental samples, be sure to include them in the protein-standard samples as well. If using ampholyte concentrations higher than 0.4%, then add them to the samples after the protein assay has been completed.

Protein samples can be applied to the assay paper either through the top wells of the microplate or through the backing plate on the bottom of the plate.

Apply a 1 μL volume of each protein standard (prepared in step 1.2) and each experimental sample to separate wells of the microplate assembly. Include a 1 μL sample of buffer alone, to serve as a no-protein control. Loading each sample in triplicate is recommended. Be careful not to puncture or scratch the membrane with the pipet tip. Gently dispense samples from the pipet tip onto the paper without touching the pipet tip to the paper. Once in contact with the paper, the sample should wick out from the tip. Pipetting accuracy can be improved by gently wiping away any sample on the outside of the pipet tip before spotting the sample onto the paper.

Allow the protein samples on the paper to dry completely. A hair dryer can be used to reduce the drying time to about a minute.

### Example 5

### Staining the Protein Standards and Samples

Wearing gloves, remove the assay paper from the microplate by depressing the spring arm of the backing plate and tilting the backing plate up and away from the assay paper. Remove the protein-spotted assay paper.

Pour about 40 mL of methanol into a plastic staining tray. Use a plastic tray slightly larger than the assay paper. If half sheets of paper are used, use ˜20 mL and a proportionally smaller tray. Place the protein-spotted assay paper into the methanol and wash, with gentle agitation, for 5 minutes. This step removes contaminating substances including urea, SDS, reducing agents, salts and dyes that may be present.

After washing, air dry the assay paper, using a hair dryer, if desired.

Pour 40 mL of the protein quantitation reagent provided in the EZQ™ Protein Quantitation Kit into a staining tray. Place the protein-spotted assay paper into the stain solution and agitate gently on an orbital shaker for 30 minutes. For half sheets of paper, use ˜20 mL and a smaller staining tray.

After staining, rinse the assay paper for 1-2 minutes in rinse buffer (10% methanol, 7% acetic acid). Repeat twice, for a total of three rinses.

If protein spots will be analyzed using a laser-based scanner or UV illuminator, wet or dry assay papers can be used. If the protein spots are to be analyzed using a fluorescence-based microplate reader, the assay paper should be dry. Air dry the assay paper on a clean, flat surface, using a hair dryer, if desired.

### Example 6

### Reading and Analyzing Assay Results

EZQ protein quantitation reagent has two excitation maxima, one at ˜280 nm and another at 450 nm. The emission maximum is at ˜618 nm. Various instruments can be used to read the fluorescence, as described below.

Place the dried paper (from step 4.6) back into the microplate and secure the backing plate. A hand-held UV light can be used to ensure the correct alignment of the paper to the wells. Analyze the stained protein spots in a fluorescence-based microplate reader using excitation/emission settings of ˜485/590 nm. Top- or bottom-reading microplate readers may be used, and it makes no difference whether the protein samples were spotted from the top or from the bottom.

For optimal results, program the microplate reader to take multiple samplings or multiple readings of each well.

Image the stained assay paper using an imaging system equipped with a 450, 473 or 488 nm laser and an appropriate emission filter (e.g., a 520 or 580 nm longpass filter, or a 600 nm bandpass filter).

To visualize the stained protein spots, illuminate the assay paper with a 300 nm transilluminator, a UV top-illuminating system or a hand-held UV-B light source. Use a photographic or CCD camera, with an appropriate filter, to generate digital images of the stained paper, and then quantitate the image with appropriate software.

Calculate the fluorescence values of the experimental samples and standards by subtracting the fluorescence value of the no-protein control. Create a standard curve (see FIG. 10) by plotting the corrected fluorescence values of the standards vs. the corresponding protein mass (or concentration). Determine the mass (or concentration) of the experimental samples from the standard curve.

### Example 7

### Exemplary Results

FIGS. 10A and 10B show assay of ovalbumin. A dilution series of ovalbumin was prepared, assayed as described above, and then quantitated using both a 473 nm laser-based scanning instrument (FIG. 10A) and a fluorescence microplate reader (FIG>10B). The assays were performed over a broad range, and the insets show the low range in greater detail. The assays were performed in triplicate, and the man values, in arbitrary fluorescence units, were plotted after subtracting background values of 86 (FIG. 10A) or 18 (FIG. 10B).

FIG. 11 shows protein-to-protein variation in the assay. Triplicate 1 μg samples of various proteins were assayed using a fluorescence-based microplate reader as described above. The mean fluorescence values, after correcting for background fluorescence, are expressed relative to that of ovalbumin. The coefficient of variation is 16%. The protein samples are: A, ovalbumin; B, bovine serum albumin; C, myoglobin; D, soybean trypsin inhibitor; E, β-casein; F, carbonic anhydrase; G, transferrin; H, mouse IgG; 1, lysozyme; and J, histone.

All of the compositions and/or methods and/or apparatus disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and/or apparatus and in the steps or in the sequence of steps of the methods described herein without departing from the concept and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the scope and concept of the invention.

What is claimed is:

1. An apparatus suitable for the separately addressable disposition of a plurality of fluid samples onto a common support that is reversibly fixed therein, the apparatus comprising a microplate component and a backing plate:
wherein the microplate component has a matrix of throughbores, the throughbores being mutually fluidly noncommunicating within the microplate component;
wherein the microplate component and backing plate are configured to mate reversibly to form a mated assembly;
wherein the microplate component and the backing plate matedly fix a support therebetween; and
wherein the mated assembly does not exceed in outermost dimensions the outermost dimensions of the microplate component.

2. The apparatus of claim 1, wherein the mated assembly is so dimensioned as to satisfy microplate dimensional standards.

3. The apparatus of claim 1, wherein the microplate component has 96 throughbores disposed in an 8×12 matrix.

4. The apparatus of claim 1, wherein the microplate component has 384 throughbores disposed in a 16×24 matrix.

5. The apparatus of claim 1, wherein the backing plate has a matrix of throughbores mutually fluidly noncommunicating within the backing plate.

6. The apparatus of claim 5, wherein the backing plate throughbores are alignable with the throughbores of the microplate component in the apparatus.

7. The apparatus of claim 5, wherein the matrix of backing plate throughbores is alignable with the matrix of microplate component throughbores in any of a plurality of relative orientations of the microplate component and backing plate.

8. The apparatus of claim 5, wherein the matrix of backing plate throughbores is alignable with the matrix of microplate component throughbores in any of 4 relative microplate component and backing plate orientations.

9. The apparatus of claim 1, wherein the backing plate is substantially rigid.

10. The apparatus of claim 1, wherein the backing plate is inwardly and elastically compressible.

11. The apparatus of claim 1, wherein the backing plate is inwardly and elastically compressible in substantially a single axis.

12. The apparatus of claim 1, wherein the backing plate has at least one integrally fashioned spring element that is inwardly and elastically compressible substantially in a single axis.

13. The apparatus of claim 12, wherein the backing plate further comprises at least one outward protrusion disposed peripherally to the spring element.

14. The apparatus of claim 1, wherein the backing plate at least one integrally fashioned spring element formed by the positioning of a void inwardly offset from and parallel to the backing plate periphery.

15. The apparatus of claim 14, wherein the backing plate further comprises at least one outward protrusion disposed peripherally to the spring element.

16. The apparatus of claim 5, further comprising at least one void positioned in the backing plate external to the outwardmost row of backing plate throughbores.

17. The apparatus of claim 1, wherein the microplate component has a recessed bottom dimensioned as to accommodate and frictionally retain the backing plate.

18. The apparatus of claim 1, wherein the backing plate has at least one chamfer.

19. The apparatus of claim 1, further comprising a support;
wherein the support is fixedly positioned between the microplate component and the backing plate;
wherein the support is positioned as to be in fluid communication with, and to occlude passage through, at least a plurality of microplate component throughbores.

20. The apparatus of claim 19, wherein the support is positioned as to be in fluid communication with, and to occlude passage through, at least a plurality of the backing plate throughbores.

21. The apparatus of claim 19, wherein the support is positioned as to occlude passage through all of the microplate component throughbores.

22. The apparatus of claim 19, wherein the support is so positioned as to occlude passage through all of the backing plate throughbores.

23. A method of commonly assaying a plurality of fluid samples for one or more desired analytes, the method comprising:
providing an apparatus comprising a microplate component and a backing plate, wherein:
the microplate component has a matrix of throughbores, the throughbores being mutually fluidly noncommunicating within the microplate component;
the microplate component and backing plate are configured to mate reversibly to form a mated assembly;
the microplate component and the backing plate matedly fix a support therebetween; and
the mated assembly does not exceed in outermost dimensions the outermost dimensions of the microplate component.
providing a plurality of fluid samples;
disposing at least one aliquot from each of the plurality of fluid samples at separately addressable locations on a support fixedly positioned between the microplate component and backing plate;
removing the support from the apparatus;
contacting the support with at least one solution comprising at least one reagent capable of signaling the presence of the one or more desired analytes; and
detecting signal at each of the separate addresses on the support.

24. The method of claim 23, further comprising:
fixedly repositioning the support between the microplate component and the backing plate of the apparatus after the contacting step and before the detecting step; and
separately detecting signal at each of the separate addresses on the support.

25. The method of claim 23, wherein the at least one aliquot is contacted with the support through the microplate component throughbores.

26. The method of claim 23, wherein the at least one aliquot is contacted with the support through the backing plate throughbores.

27. The method of claim 23, further comprising washing the support with at least one wash solution after the removing step and before the contacting step.

28. The method of claim 23, further comprising washing the support with at least one wash solution after the contacting step and before the detecting step.

29. The method of claim 23, wherein the one or more signaling reagents signals the presence of the one or more desired analytes calorimetrically.

30. The method of claim 23, wherein the one or more signaling reagents signals the presence of the one or more desired analytes fluorescently.

31. The method of claim 23, wherein the one or more signaling reagents signals the presence of the one or more desired analytes luminescently.

32. The method of claim 23, wherein the one or more desired analytes are proteins.

33. The method of claim 23, wherein the one or more desired analytes are nucleic acids.

34. The method of claim 23, wherein the one or more desired analytes are lipids.

35. A kit comprising:
an apparatus comprising a microplate component and a backing plate, wherein:
the microplate component has a matrix of throughbores, the throughbores being mutually fluidly noncommunicating within the microplate component;
the microplate component and backing plate are configured to mate reversibly to form a mated assembly;
the microplate component and the backing plate matedly fix a support therebetween; and
the mated assembly does not exceed in outermost dimensions the outermost dimensions of the microplate component; and
at least one support dimensioned as to be fixedly positionable between the microplate component and the backing plate.

36. The kit of claim 35, comprising a plurality of supports dimensioned as to be fixedly positionable between the microplate component and the backing plate.

37. The kit of claim 35, wherein the support includes at least one indicium that facilitates the identification of its orientation.

38. The kit of claim 35, further comprising at least one analyte standard.

39. The kit of claim 35, further comprising at least one solution comprising at least one analyte-signaling reagent.
